(19) United States
(12) Patent Application Publication
(10) Pub. No.: US 2003/0172273 A1
(43) Pub. Date: Sep. 11, 2003

(54) Method for controlling the distribution of data

(76) Inventor: Sjoblom Hans, Are (SE)

Correspondence Address: Steven S. Payne, 8027 Iliff Drive, Dunn Loring, VA, 22027, US

(21) Appl. No.: 10/087,864

(22) Filed: Mar. 5, 2002

(51) Int. Cl. H04L 9/00

(52) U.S. Cl. 713/172

(57) ABSTRACT

A method for protecting digital information which places a financial risk on a purchaser of digital information if the digital information is illegally copied is disclosed. The digital information being purchased is first encoded using a public key before being distributed to the purchaser. Each time the digital information is used, the digital information must be decoded using a private key which is stored on a smart card such as a credit card or an identification card, wherein the private key can not be used until the user of the smart card has been properly authenticated.

### FIELD OF THE INVENTION

The invention relates to the distribution of data, and more particularly to controlling the use of the distributed data so as to make it financially risky for the user to illegally copy and distribute the data.

### BACKGROUND OF THE INVENTION

The explosion in the use of computers and networks such as the Internet has lead to problems with respect to the protection of rights to data and information. These problems are a result of the ease at which digital information can be transmitted and copied.

The storage of information in digital form depends on the ability to encode information in binary form to arbitrary precision and to record that binary form in a physical medium that can take on two distinct characteristics. Preserving the fidelity of information recorded in binary is easily accomplished. For example, a compact disc stores information as the presence or absence of a hole that reflects or does not reflect light. Compared to the analog recording of phonographic records, the information stored in each hole is unambiguously a binary digit, the value of which is either zero or one. No other values are possible. Digitally stored information may include binary data, computer software, text, graphics, audio, and video. The uses of this information include news, entertainment, education and analysis. Information may be distributed in many ways, including networks, magnetic media, CD-ROM, semiconductor memory modules, and wireless broadcast.

A digital file can be copied with no loss of fidelity. As a result, it is now almost impossible to differentiate a digital copy from the digital original. In a network environment, recording materials, reproduction equipment and distribution are not implements to copying. Consequently, in the digital domain, the threshold inhibiting the making of illegal copies is significantly lowered. This is a particular problem for computer software, music, literature, audio and/or video information. This illegal copying of digital information results in billions of dollars worth of lost sales.

To combat the illegal copying of digital information, many different technical solutions have been developed. Unfortunately, these technical solutions usually make it harder for the purchasing consumer to use the software or information. In addition, people intent on illegally copying the digital information simply devise new ways of getting around the protection schemes. As a result, many companies have abandoned these technical solutions.

Another problem with illegal copying is that many consumers do not realize that their actions are in fact illegal. They do not view making a copy of a new computer game for a friend to be illegal. Furthermore, even if the person does realize that his/her actions are illegal, the person knows that the software company or music company will not be coming after individual people so long as the illegal copying is kept to just several copies. In other words, there is virtually no risk involved for the “small time” copier.

Another method for protecting digital information is disclosed in U.S. Pat. No. 6,005,935. In this method, the purchaser provides the seller of the digital information with personal information such as purchaser's name, address, telephone number, mother's maiden name, spouse's name, children's names, birthdate, social security number, credit card number, and/or bank account information. The seller then encrypts the digital information using a key made up from some of the personal information. The purchaser is then prompted to enter the personal information before being granted access to the digital information. The problem with this solution is that prospective purchasers will very wary of giving all of this personal information to an individual or company who they do not know. With all of this personal information, the seller can make fraudulent purchases which would be charged to the innocent purchaser. As a result, the prospective purchaser will be more inclined to buy the digital information or a suitable equivalent of the digital information from another seller who does not require such personal information from their purchasers.

Thus, there is a need for a method for protecting digital information which provides protection for both the seller and purchaser while placing a risk on each purchaser of digital information if the information is illegally copied.

### SUMMARY OF THE INVENTION

It is an object of the invention to overcome the above-described deficiencies of the prior art by disclosing a method for protecting digital information which places a financial risk on a purchaser of digital information if the digital information is illegally copied. According to one embodiment of the invention, the digital information being purchased is first encoded using a public key before being distributed to the purchaser. Each time the digital information is used, the digital information must be decoded using a private key which is stored on a smart card such as a credit card or an identification card, wherein the private key can not be used until the user of the smart card has been properly authenticated.

According to one embodiment of the invention, a method for controlling the use of data on a device by a user is disclosed. A smart card is issued to the user by a first party, wherein a private key which is assigned to the user is stored on the smart card, wherein the private key is usable but not known by the user and the private key can not be used until the card is activated by authenticating that the user is authorized to use the smart card. The data to be sent to the user is encrypted using a public key assigned to the user before distributing the data to the user. After distribution of the data to the user, the user is prompted to enter a private key each time the user wants to use the data, wherein the user inserts the smart card into a smart card reader connected to the device and activates the smart card, wherein the device decrypts the encrypted data using the private key.

According to another embodiment of the invention, a method for controlling the use of data on a device by a user is disclosed. A smart card is issued to the user by a first party, wherein a first private key which is assigned to the user is stored on the smart card, wherein the first private key is usable but not known by the user and the first private key can not be used until the card is activated by authenticating that the user is authorized to use the smart card. The user then obtains at least a second set of public and private keys and storing the at least second private key on the smart card. The data to be sent to the user is encrypted using a first public key assigned to the user and the second public key before distributing the data to the user. After distribution of the data to the user, the user is prompted to enter the first and at least second private keys each time the user wants to use the data, wherein the user inserts the smart card into a smart card reader connected to the device and activates the smart card, wherein the device decrypts the encrypted data using the first and at least second private keys.

According to another embodiment of the invention, a method for controlling the use of data on a device by a user is disclosed. The data to be sent to the user is encrypted using at least one public key assigned to the user before distributing the data to the user. After distribution of the data to the user, the user is prompted to enter at least one private key each time the user wants to use the data, wherein the at least one private key is stored on a smart and the at least one private key is usable but not known by the user and the at least one private key can not be used until the card is activated by authenticating that the user is authorized to use the smart card, wherein the user inserts the smart card into a smart card reader connected to the device and activates the smart card, wherein the device decrypts the encrypted data using the private key.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a system in which the various embodiment of the invention can operate;

FIG. 2 is a flow chart illustrating the operation of the method for protecting digital information according to one embodiment of the invention; and

FIG. 3 is a flow chart illustrating the operation of the method for protecting digital information according to another embodiment of the invention.

### DETAILED DESCRIPTION

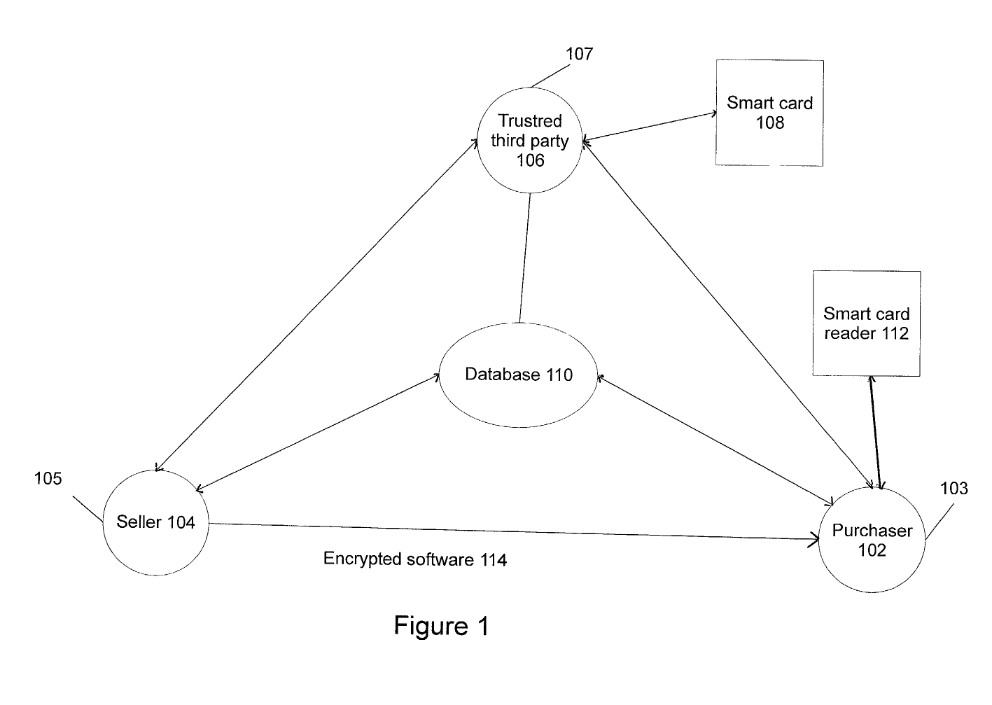

FIG. 1 illustrates the parties of a transaction performed in accordance with one embodiment of the invention. The main parties to the transaction are the purchaser 102, the seller, 104 and a trusted third party 106 such as a bank or a credit card company. Each of the parties has a computer system 103, 105 and 107, respectively. The purchaser's computer system may be any number of electronic devices with processing capabilities for processing digital information, such as a personal computer, personal digital assistant, television, music system, etc. The purchaser's computer system 103 also has a smart card reader 112 either built into the system or attached thereto.

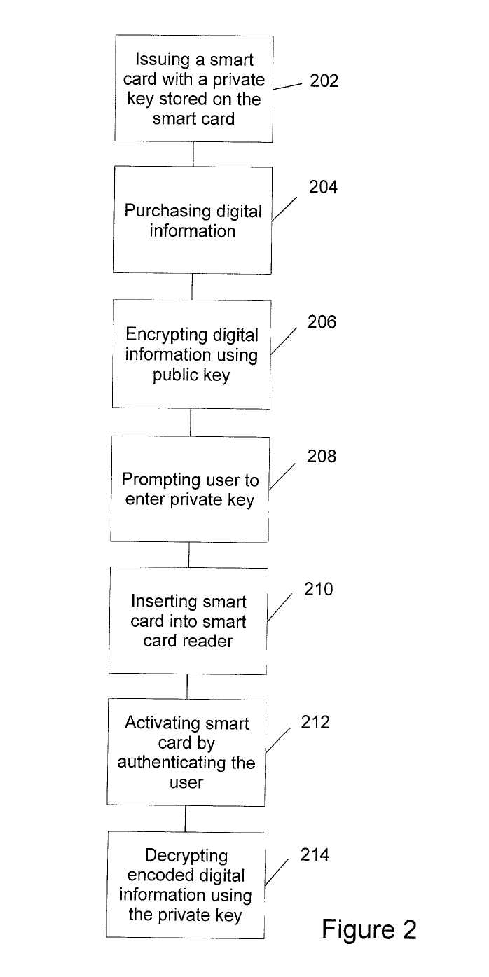

A method for protecting digital information from illegal copying according to one embodiment of the invention will now be described with reference to FIG. 2. The invention uses asymmetric keys in the transaction. Asymmetric keys comprise a public key and a private key, wherein information encrypted with a public key can only be decrypted by the private key and vice versa. In this embodiment of the invention, a purchaser 102 obtains a smart card 108 from the trusted third party 106 in step 202. The smart card 108 can be a credit card, debit card, identification card, etc. Prior to giving the smart card 108 to the purchaser 102, the trusted third party (or someone hired by the trusted third party) 106 selects an asymmetric pair of keys for the purchaser and stores the private key on the smart card 108. The private key is stored on the smart card 108 in such a manner that the private key can be used by the purchaser 102 but is not known by the purchaser 102 or at least makes it difficult for the purchaser to discover the private key. The public key is then given to the purchaser and/or placed in a public database 110. The purchaser then selects an activation code such as a personal identification code (PIN) or some biometric identification code which is also stored on the smart card 108.

In step 204, when the purchaser 102 wants to buy digital information, e.g., computer software, music, literature, audio and/or video information, etc., the purchaser contacts the seller 104, for example over the Internet or via telephone but the invention is not limited thereto. Once the seller 104 and the purchaser 102 have agreed to the sale of the digital information, the seller 104 retrieves the purchaser's public key from either the purchaser 102 or the database 110. The seller then encrypts the digital information using the purchaser's public key on the seller's computer system 105 in step 206. The seller then sends the encoded digital information to the purchaser by uploading/downloading the encoded digital information to the purchaser's computer system 103, mailing the encoded digital information on a CD to the purchaser, or the like. The purchaser 102 then pays the trusted third party 106 for the digital information and the trusted third party pays the seller 104.

Each time the purchaser wants to use the encoded digital information, the purchaser 102 is prompted, in step 208, by whatever electronic device is trying to use the encoded digital information, such as the computer system 103, to enter the private key so that the encoded digital information can be decoded. The purchaser 102 then inserts the smart card 108 into the smart card reader 112 in step 210. However, before the computer system 103 can access the private key stored on the smart card 108, the purchaser must first activate the smart card by entering the correct activation code or biometric identification code so as to authenticate that the purchaser is the proper user of the smart card 108 in step 212. The biometric identification code can be entered using a biometric scanner (not illustrated) or the like connected to the computer system 103. Once the smart card has been properly activated, the computer system 103 (or a processing device connected to the computer system 103) can access the private key and then use the private key to decrypt the encoded digital information in step 214. Alternatively, a processor in the smart card 108 can be used to decrypt the encoded digital information. By performing the decryption in the smart card, the private key never leaves the smart card which makes it very difficult for someone to steal the private key.

In this embodiment of the invention, the purchaser 102 gives the seller 104 some personal information, i.e., the public key, but the seller cannot fraudulent use the information since the seller does not know the private key and activation code. Thus, the purchaser 102 is protected from fraudulent actions by the seller 104. In addition, the purchaser's smart card and activation code are needed whenever someone wants to use the digital information. Since most people will not want to give control of their smart card and activation code to friends or strangers, the digital information is protected from illegal copying.

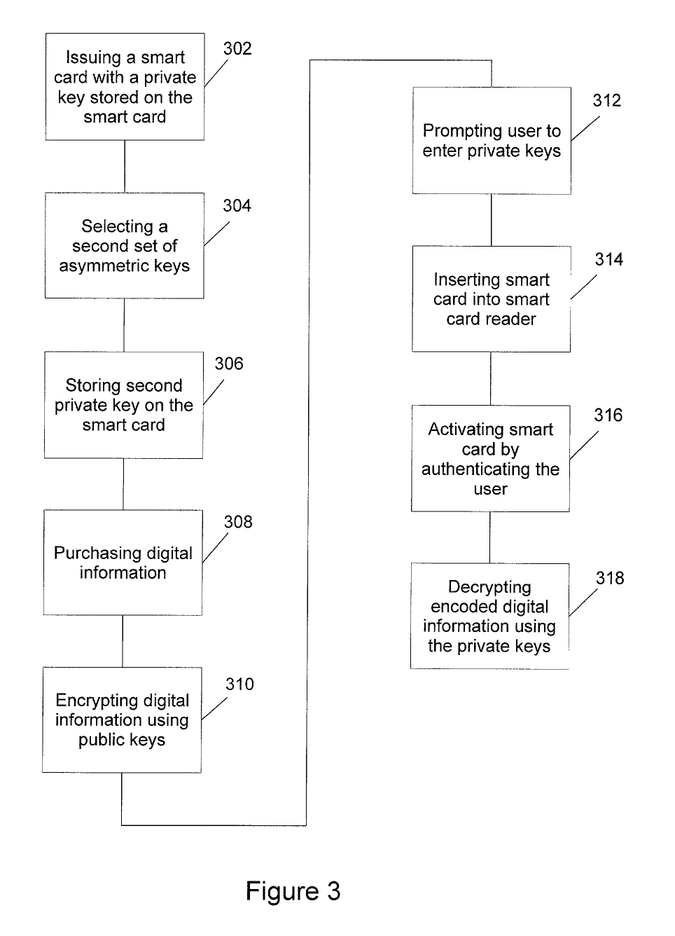

One drawback with the above-described embodiment of the invention is that the trusted third party 106 may know all of the personal information (public key, private key, activation code) of the purchaser 102. In order to provide an extra layer of security for the purchaser 102, at least a second set of asymmetric keys can be used in the transaction as illustrated in FIG. 3. In this embodiment of the invention, a purchaser 102 obtains a smart card 108 from the trusted third party 106 in step 302. Prior to giving the smart card 108 to the purchaser 102, the trusted third party (or someone hired by the trusted third party) 106 selects a first asymmetric pair of keys for the purchaser and stores the first private key on the smart card 108. The first private key is stored on the smart card 108 in such a manner that the first private key can be used by the purchaser 102 but is not known by the purchaser 102 or at least makes it difficult for the purchaser to discover the first private key. The first public key is then given to the purchaser and/or placed in a public database 110. The purchaser then selects an activation code such as a personal identification code (PIN) or some biometric identification code which is also stored on the smart card 108 which is used to authenticate the identity of the user.

Once the purchaser has received the smart card 108, the purchaser selects at least a second pair of asymmetric keys in step 304. While the rest of this illustrative description will discuss just a second pair of asymmetric keys, it will be understood by one skilled in the art that multiple pairs of asymmetric keys could also be selected and used by the purchaser. The purchaser 102 then stores the second private key on the smart card 108 in step 306 and either keeps and/or sends the second public key to the public database 110. The purchaser 102 may use a machine at the offices of the trusted third party, the Internet or a variety of other means, such as an enhanced smart card reader/burner, for selecting and storing the second pair of asymmetric keys. As a result, only the purchaser 102 knows the second private key stored on the smart card 108.

In step 308, when the purchaser 102 wants to buy digital information, e.g., computer software, music, literature, audio and/or video information, etc., the purchaser contacts the seller 104, for example over the Internet or via telephone but the invention is not limited thereto. Once the seller 104 and the purchaser 102 have agreed to the sale of the digital information, the seller 104 retrieves the purchaser's first and second public keys from either the purchaser 102 or the database 110. The seller then encrypts the digital information using the purchaser's first and second public key on the seller's computer system 105 in step 310. The seller then sends the encoded digital information to the purchaser by uploading/downloading the encoded digital information to the purchaser's computer system 103, mailing the encoded digital information on a CD to the purchaser, or the like. The purchaser 102 then pays the trusted third party 106 for the digital information and the trusted third party pays the seller 104.

Each time the purchaser wants to use the encoded digital information, the purchaser 102 is prompted, in step 312, by whatever electronic device is trying to use the encoded digital information, such as the computer system 103, to enter the first and second private keys so that the encoded digital information can be decoded. The purchaser 102 then inserts the smart card 108 into the smart card reader 112 in step 314. However, before the computer system 103 can access the private keys stored on the smart card 108, the purchaser must first activate the smart card by entering the correct activation code or biometric identification code so as to authenticate that the purchaser is the proper user of the smart card 108 in step 316. Once the smart card has been properly activated, the computer system 103 (or a processing device connected to the computer system) can access the first and second private keys and then use the first and second private keys to decrypt the encoded digital information in step 318. Alternatively, a processor in the smart card 108 can be used to decrypt the encoded digital information.

In this embodiment of the invention, since the seller 104 and the trusted third party 106 do not know the second private key, the purchaser 102 is protected from the fraudulent use of the personal information by the seller 104 and the trusted third party 106. At the same time, the digital information is protected from illegal copying by the financial risk the purchaser would be exposed to if the purchaser gives his/her smart card and activation code to other people.

The above-described embodiments of the invention provide an improved method for protecting digital information from illegal copying while also providing a method of transacting a sale in which all of the parties take no additional risks than are normally present in a transaction. It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

We claim:

1. A method for controlling the use of data on a device by a user, comprising the steps of:
issuing a smart card to the user by a first party, wherein a private key which is assigned to the user is stored on the smart card, wherein the private key is usable but not known by the user and the private key can not be used until the card is activated by authenticating that the user is authorized to use the smart card;
encrypting data to be sent to the user using a public key assigned to the user before distributing the data to the user; and
after distribution of the data to the user, prompting the user to enter a private key each time the user wants to use the data, wherein the user inserts the smart card into a smart card reader connected to the device and activates the smart card, wherein the device decrypts the encrypted data using the private key.

2. The method according to claim 1, wherein the smart card is a credit card.

3. The method according to claim 1, wherein the smart card is an identification card.

4. The method according to claim 1, wherein the data is digital information comprises one of computer software, music, literature, audio and/or video information.

5. The method according to claim 1, wherein the public and private keys are asymmetric public and private keys.

6. The method according to claim 5, wherein the asymmetric public key for the user is obtained from the user.

7. The method according to claim 5, wherein the asymmetric public key for the user is obtained from a public database.

8. The method according to claim 1, wherein the user authenticates the smart card by entering a personal identification number code.

9. The method according to claim 1, wherein the user authenticates the smart card by entering a biometric identification code.

10. The method according to claim 1, wherein a processor in the smart card decrypts the encrypted data using the private key.

11. A method for controlling the use of data on a device by a user, comprising the steps of:
issuing a smart card to the user by a first party, wherein a first private key which is assigned to the user is stored on the smart card, wherein the first private key is usable but not known by the user and the first private key can not be used until the card is activated by authenticating that the user is authorized to use the smart card;
obtaining at least a second set of public and private keys and storing the at least second private key on the smart card;
encrypting data to be sent to the user using a first public key assigned to the user and the second public key before distributing the data to the user; and
after distribution of the data to the user, prompting the user to enter the first and at least second private keys each time the user wants to use the data, wherein the user inserts the smart card into a smart card reader connected to the device and activates the smart card, wherein the device decrypts the encrypted data using the first and at least second private keys.

12. The method according to claim 11, wherein the smart card is a credit card.

13. The method according to claim 11, wherein the smart card is an identification card.

14. The method according to claim 11, wherein the data is digital information comprises one of computer software, music, literature, audio and/or video information.

15. The method according to claim 11, wherein the public and private keys are asymmetric public and private keys.

16. The method according to claim 15, wherein the asymmetric public keys for the user are obtained from the user.

17. The method according to claim 15, wherein the asymmetric public keys for the user are obtained from a public database.

18. The method according to claim 11, wherein the user authenticates the smart card by entering a personal identification number code.

19. The method according to claim 11, wherein the user authenticates the smart card by entering a biometric identification code.

20. The method according to claim 11, wherein a processor in the smart card decrypts the encrypted data using the private key.

21. A method for controlling the use of data on a device by a user, comprising the steps of:
encrypting data to be sent to the user using at least one public key assigned to the user before distributing the data to the user; and
after distribution of the data to the user, prompting the user to enter at least one private key each time the user wants to use the data, wherein the at least one private key is stored on a smart and the at least one private key is usable but not known by the user and the at least one private key can not be used until the card is activated by authenticating that the user is authorized to use the smart card, wherein the user inserts the smart card into a smart card reader connected to the device and activates the smart card, wherein the device decrypts the encrypted data using the private key.

22. The method according to claim 21, wherein the smart card is a credit card.

23. The method according to claim 21, wherein the smart card is an identification card.

24. The method according to claim 21, wherein the data is digital information comprises one of computer software, music, literature, audio and/or video information.

25. The method according to claim 21, wherein the at least one public and private keys are asymmetric public and private keys.

26. The method according to claim 25, wherein the at least one asymmetric public key for the user is obtained from the user.

27. The method according to claim 25, wherein the at least one asymmetric public key for the user is obtained from a third party.

28. The method according to claim 21, wherein the user authenticates the smart card by entering a personal identification number code.

29. The method according to claim 21, wherein the user authenticates the smart card by entering a biometric identification code.

30. The method according to claim 21, wherein the user knows all of the private keys except for one private key.

31. The method according to claim 21, wherein a processor in the smart card decrypts the encrypted data using the private key.

32. A method for controlling the use of data on a device by a user, comprising the steps of:
encrypting data to be sold to the user by a seller using at least one public key assigned to the user before distributing the data to the user; and
after distribution of the data to the user, the user is prompted by the device to enter at least one private key each time the user wants to use the data, wherein the at least one private key is stored on a smart and the at least one private key is usable but not known by the user and the at least one private key can not be used until the card is activated by authenticating that the user is authorized to use the smart card, wherein the user inserts the smart card into a smart card reader connected to the device and activates the smart card, wherein the device decrypts the encrypted data using the private key.
